(19) United States
(12) Patent Application Publication
(10) Pub. No.: US 2004/0136041 A1
(43) Pub. Date: Jul. 15, 2004

(54) Two-dimensional optical scanner, and image display system

(76) Inventor: Takayoshi Togino, Tokyo (JP)

Correspondence Address: John C. Altmiller, Esq., Kenyon & Kenyon, Suite 700, 1500 K Street, N.W., Washington, DC, 20005, US

(21) Appl. No.: 10/611,986

(22) Filed: Jul. 3, 2003

(30) Foreign Application Priority Data
Jul. 30, 2002 (JP) 2002-220806

(51) Int. Cl. G02B 26/08

(52) U.S. Cl. 359/196; 359/834

(57) ABSTRACT

The invention relates to a two-dimensional optical scanner in which distortions upon scanning can be reduced in simplified construction and a compact, energy-saving image display system using the same. The two-dimensional optical scanner comprises a light source 10, a scanner unit 2 of gimbal structure for scanning a light beam therefrom in a two-dimensional direction and a scanning optical system 20 comprising a non-rotationally symmetric surface having an action of correcting a distortion upon scanning of the scanned light beam. The scanning optical system 20 comprises a decentered prism 20 comprising an entrance surface 22, at least one reflecting surface 23 and an exit surface 21. At least one of the entrance surface, reflecting surface and exit surface comprises a non-rotationally symmetric surface.

This application claims benefit of Japanese Application No. 2002-220806 filed in Japan on Jul. 30, 2002, the contents of which are incorporated by this reference.

### BACKGROUND OF THE INVENTION

The present invention relates generally to a two-dimensional optical scanner for image formation by two-dimensional scanning and an image display system using the same, and more particularly to an optical scanner having a gimbal structure with reduced distortions upon scanning and an image display system using the same.

The applicant has come up with an optical scanner in JP-A's 2001-174740, 2001-281583, etc. More specifically, JP-A 2001-174740 discloses a small-format scanner designed such that the center beam of incident beams is substantially in line with the center beam of emergent beams, and JP-A 2001-281583 shows a small-format optical scanner comprising a combination of a single two-dimensional reflecting mirror with a decentered prism.

### SUMMARY OF THE INVENTION

Thus, the present invention provides a two-dimensional optical scanner, comprising:

a light source,

a scanner unit for scanning a light beam from said light source on the surface to be scanned in a two-dimensional direction, and

a scanning optical system having a non-rotationally symmetric surface, wherein:

said scanner unit has a gimbal structure, and

said scanning optical system comprises a decentered prism having an entrance surface through which a light beam scanned by said scanner unit enters said prism, at least one reflecting surface for allowing a light beam entered from said entrance surface in said prism to be reflected in said prism and an exit surface through which a light beam reflected at said reflecting surface leaves said prism, wherein at least one of said entrance surface, said reflecting surface and said exit surface comprises a non-rotationally symmetric surface.

The present invention also provides an image display system, comprising:

a light source,

a scanner unit of for scanning a light beam from said light source on the surface to be scanned in a two-dimensional direction,

a scanning optical system having a non-rotationally symmetric surface, and

an eyepiece optical system located in the vicinity of said surface to be scanned and having positive power, wherein:

said scanner unit has a gimbal structure, and

said scanning optical system comprises a decentered prism having an entrance surface through which a light beam scanned by said scanner unit enters said prism, at least one reflecting surface allowing a light beam entered from said entrance surface in said prism to be reflected in said prism and an exit surface through which a light beam reflected at said reflecting surface leaves said prism, wherein at least one of said entrance surface, said reflecting surface and said exit surface comprises a non-rotationally symmetric surface.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative of the scanner unit having a gimbal structure and how two-dimensional scanning is performed by means of the scanner unit.

FIG. 2 is a representation of distortions upon scanning of the optical scanner using the scanner unit having the gimbal structure of FIG. 1.

FIG. 3 is illustrative in conception of the image display system according to the invention.

FIG. 4 is illustrative in conception of the image display system capable of viewing 3D images according to the invention.

FIG. 5 is illustrative of how to find the arithmetic mean roughness Ra vs. mean pit-and-projection space Sm relations of a transmission type diffusing plate in the invention.

FIG. 6 is illustrative of the angle-of-incidence vs. angle of refraction on the diffusing surface of the transmission type diffusing plate.

FIG. 7 is illustrative of how to find the arithmetic mean roughness Ra vs. mean pit-and-projection space Sm relations of a reflection type diffusing plate in the invention.

FIG. 8 is illustrative of the angle-of-incidence vs. angle of refraction on the diffusing surface of the reflection type diffusing plate.

FIG. 9 is illustrative of the Sm/Ra vs. half angle of diffusion relations for a diffusing plate in the invention.

FIG. 10 is illustrative of the scanning direction of the two-dimensional scanning mirror where the decentered prism is located obliquely with respect to the center of the surface to be scanned.

FIG. 11 is illustrative in a Y-Z section of the whole arrangement of the optical system according to Inventive Example 1 from the surface to be scanned to the light source.

FIG. 12 is an optical path diagram in the Y-Z section for a substantial part of the optical system of Inventive Example 1.

FIG. 13 is illustrative in a Y-Z section of the whole arrangement of the optical system according to Inventive Example 2 from the surface to be scanned to the light source.

FIG. 14 is an optical path diagram in the Y-Z section for a substantial part of the optical system of Inventive Example 2.

FIG. 15 is an optical path diagram for the whole arrangement of the optical system according to Inventive Example 3 from the surface to be scanned to the light source, as projected onto a Y-Z plane.

### DESCRIPTION OF THE PREFERRED EMBODIMENTS

The reasons for using the aforesaid arrangements in the invention and how they work will now be explained in detail.

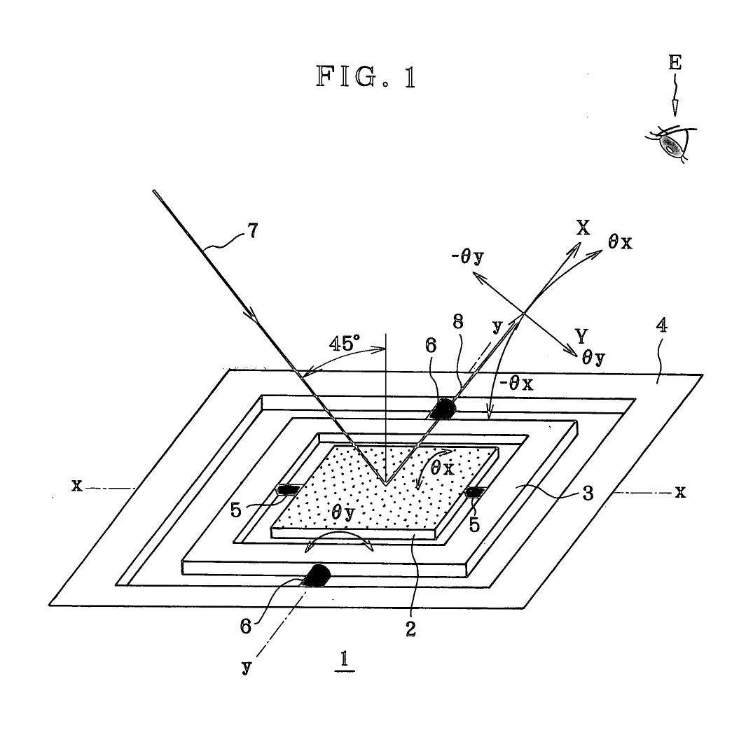

FIG. 1 is illustrative of the scanner unit having a gimbal structure and how to perform two-dimensional scanning with that scanner unit. The scanner unit 1 comprises a scanning mirror 2, a middle framework 3 and an outer framework 4. The scanning mirror 2 is coupled to the middle framework 3 by a shaft 5 that extends in an x-x axis direction. Then, the middle framework 3 is coupled to the outer framework 4 that is fixed by means of a shaft 6 extending in a y-y axis direction orthogonal to the x-x axis. Thus, light reflected at the scanning mirror 2 is horizontally scanned (X-direction scanning) by fluctuating motion of the scanning mirror 2 around the shaft 5, and vertically scanned (Y-direction scanning) by fluctuating motion of the middle framework 3 and scanning mirror 2 around the shaft 6. The fluctuating motion around the shafts 5 and 6 may be induced in various driving fashions such as electromagnetic driving, electrostatic driving, and piezoelectric driving. That fluctuating motion could also be induced by virtue of elastic deformation of the shafts 5 and 6, or free rotation around the shaft 5 and 6.

The scanner unit 1 comprising a gimbal structure with two axes, x-x and y-y axes, as shown in FIG. 1, is one typical micromachine developed while keeping pace with the recent advancement of lithography. The scanning mirror 2 of some mm square enables a two-dimensional image to be scanned and displayed by virtue of a light beam reflected thereat.

To prevent any interference of a light beam upon reflection at the scanning mirror 2 with the light source, a half-silvered mirror or the like must be used or a light beam must be obliquely incident on the scanning mirror. A problem with the use of the half-silvered mirror is that the structure involved becomes complicated. Through the half-silvered mirror, a light beam incident on the scanning mirror 2 transmits and a light beam reflected back at the scanning mirror 2 transmits; a total of two light beams pass through the half-silvered mirror, causing the quantity of light to reduce to ¼.

It is thus desirable to enter a light beam obliquely with respect to the scanning mirror 2. It is noted, however, that a problem with oblique incidence of light rays on a scanning mirror having a gimbal structure is a distortion of the light beam scanned.

Suppose now that an incident light beam 7 is obliquely incident on the reflecting surface of the scanning mirror 2. In this case, the positions in the X- and Y-directions of the reflected light beam 8 on the surface to be scanned are not determined in proportion to the angle of rotation θₓ around the x-x axis and the angle of rotation θ_{y} around the y-y axis. Even with the angle of rotation θ_{y} fixed as shown typically in FIG. 1, there is a distortion (e.g., a circular arc distortion) of scanning lines, which may otherwise cause a change in the Y-direction position depending on the value of the angle of rotation θₓ. Such a distortion of scanning lines incurs a distortion of images on the surface to be scanned. That distortion is hereinafter referred to as the distortion upon scanning.

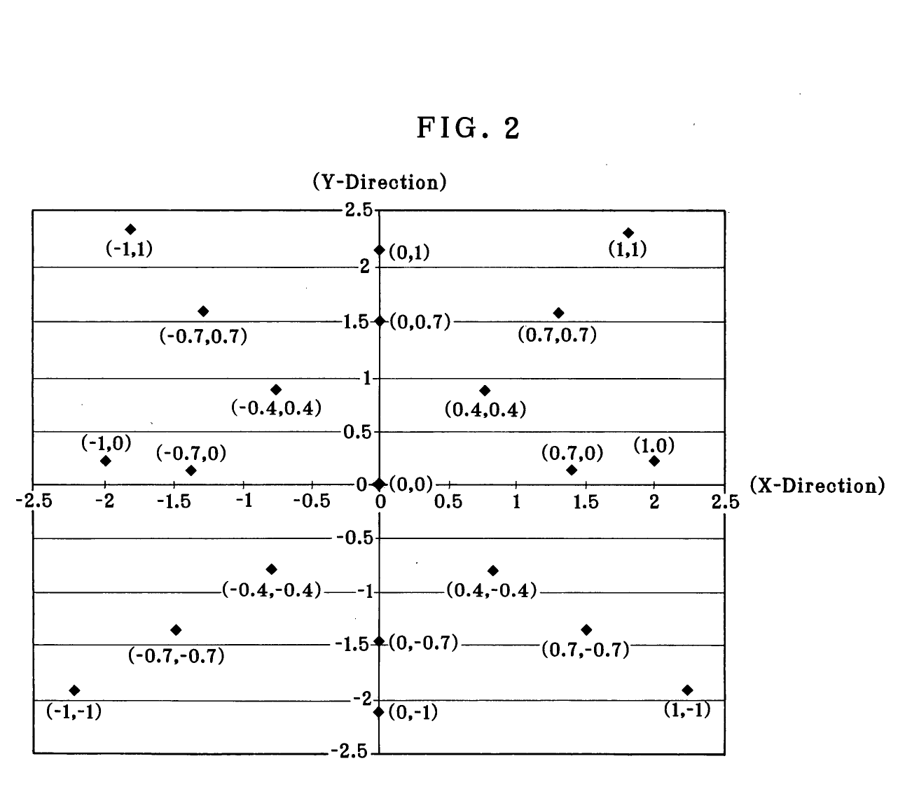

In FIG. 2, the positions of the beam on the surface to be scanned, which correspond to the values of (θₓ/θ_{x max}, θ_{y}/θ_{y max}) when the angle of incidence of the incident light beam 7 is 45°, are expressed in terms of (X, Y). Assume here that when the angle of rotation θₓ around the x-x axis is zero, the normal to the scanning mirror 2 lies in a plane including the incident light beam 7 and x-x axis. In the absence of any distortion upon scanning, a frame connecting together (1, 1)-(1, 0)-(1, −1)-(0, −1)-(−1, −1)-(−1, 0)-(−1, 1)-(0, 1)-(1, 1) takes the form of a rectangle. With the optical scanner using the scanner unit 1 having a gimbal structure as shown in FIG. 1, however, there is such a distortion upon scanning as typically shown in FIG. 2. FIG. 2 is illustrative of coordinates at a position 10-mm away from the scanning mirror 2 when fluctuated ±6° in the X-direction and ±8° in the Y-direction.

As shown in FIG. 2, the resulting distortion upon scanning assumes a composite form comprising a distortion component that takes a bow form even on the Z-axis (optical axis), a generally trapezoidal distortion component and a generally pin-cushion distortion component. This intricate distortion upon scanning could be corrected by use of a non-rotationally symmetric surface.

To make correction for such a distortion upon scanning, the invention relies on a decentered prism. This decentered prism comprises an entrance surface through which a light beam scanned by the two-dimensional scanner unit 1 enters the prism, at least one reflecting surface for reflection in the prism of a light beam entered in the prism through the entrance surface, and an exit surface through which a light beam reflected at that reflecting surface leaves the prism. In the invention, at least one of the entrance surface, the reflecting surface and the exit surface is defined by a non-rotationally symmetric surface. By incorporation of such a decentered prism in the scanning optical system, it is possible to make correction for such an intricate distortion upon scanning as described above.

An account is now given of why such a decentered prism comprising at least one non-rotationally symmetrical surface is used in the scanning optical system. A refracting optical element like a lens cannot have power without imparting a curvature to its boundary surface. Upon light rays refracted at the boundary surface of the lens, therefore, chromatic aberrations occur unavoidably due to the chromatic dispersion of the refracting optical element. For this reason, another refracting optical element is generally added to that refracting optical element for the purpose of correction of chromatic aberrations.

In principle, on the other hand, a reflecting optical element like a mirror or prism is free from chromatic aberrations even with power given to its reflecting surface. Therefore, it is not necessary to use another optical element only for the purpose of correction of chromatic aberrations. Thus, an optical system incorporating a reflecting optical element enables the number of optical elements for correction of chromatic aberrations to be more reduced as compared with an optical system incorporating a refracting optical element.

At the same time, the reflecting optical system incorporating a reflecting optical element can be smaller than the refracting optical system, because an optical path can be folded.

However, a reflecting surface is higher in sensitivity to decentration errors than a refracting surface, and so requires higher assembly precision. Of reflecting optical elements, however, a prism is designed such that the positions of the respective surfaces are fixed, so that higher assembly precision and more control steps than required are not needed because only control of decentration of the prism itself is needed.

Moreover, the prism comprises an entrance surface and an exit surface, each defined by a refracting surface, as well as a reflecting surface, and so is greater in the flexibility in correction of aberrations than a mirror consisting of a reflecting mirror only. Especially if a substantial portion of desired power is allocated to the reflecting surface, the power of the refracting entrance and exit surfaces can then be reduced, so that while the flexibility in correction of aberrations is kept higher than can be achieved with a mirror, the amount of chromatic aberrations can be much more reduced as compared with a refracting optical element such as a lens. The prism is also filled therein with a transparent material having a refractive index higher than that of air, so that an optical path of longer length can be taken than can be achieved with air and, hence, more size and thickness reductions can be obtained than can be achieved with a lens or mirror located in the air.

For the scanning optical system, it is required to have satisfactory image-formation capability not only at the center but also as far as the periphery. In the case of a general coaxial optical system, the sign of the height of off-axis light rays reverses before and after a stop. In this case, off-axis aberrations become worse because the symmetry of an optical element with respect to the stop collapses. Generally, the symmetry of the optical element with respect to the stop is well satisfied by interposing the stop between refracting surfaces, thereby making correction of off-axis aberrations.

According to the invention, such an intricate distortion upon scanning as described above can be corrected by use of a decentered prism comprising an entrance surface through which a light beam scanned by the two-dimensional scanner unit enters the prism, at least one reflecting surface for reflection in the prism of a light beam entered in the prism through the entrance surface, and an exit surface through which a light beam reflected at that reflecting surface leaves the prism, wherein at least one of the entrance surface, the reflecting surface and the exit surface is defined by a non-rotationally symmetric surface.

Preferably but not exclusively, a free-form surface should be used for the non-rotationally symmetric surface shape. The free-form surface, for instance, is defined by formula (a) in U.S. Pat. No. 6,124,989 (JP-A 2000-66105), and the Z-axis of that defining formula provides the axis of the free-form surface.

By constructing at least one of such non-rotationally symmetric surfaces of a transmitting surface, such a distortion upon scanning as described above can be corrected.

By constructing at least one of such non-rotationally symmetric surfaces of a reflecting surface, the distortion upon scanning can be more reduced.

When there are two or more reflecting surfaces, the distortion upon scanning can be much more reduced by constructing at least two reflecting surfaces of non-rotationally symmetric surfaces.

More preferably, a light-emitting element such as a LED (light-emitting diode) or LD (laser diode) should be used as the light source in such a scanning optical system. By use of that light-emitting element, it is possible to reduce the size of a light source portion and, hence, the overall size of the system. The use of such a light source enhances color reproducibility, rendering red particularly clear.

It is understood that images can be displayed in color by use of a light source containing R (red), G (green) and B (blue).

More preferably, a light beam from the light source should be collimated through an optical element having positive power for incidence the scanning mirror, thereby reducing the effective diameter of an optical system portion near the scanning mirror and, hence, the overall size of the system.

Preferably in the invention, a decentered prism comprising an entrance surface through which a light beam scanned by the scanner unit enters the prism, a first reflecting surface for reflection in the prism of the light beam entered from that entrance surface, a second reflecting surface for reflection in the prism of a light beam reflected at that first reflecting surface and an exit surface through which a light beam reflected at that second reflecting surface leaves the prism, wherein the entrance surface and the second reflecting surface are defined by a single combined surface, is used in the scanning optical system.

With this decentered prism where no optical path is bent on the side opposite to the light beam-emerging side (projection surface side), it is possible to decrease the angle that the light beam incident on the scanning mirror subtends the light beam reflected at the scanning mirror. This is preferable for correction of the distortion upon scanning because there can be provided a layout where the light beam scanned by the scanning mirror has little or no distortion upon scanning.

According to another embodiment of the invention, a decentered prism comprising an entrance surface through which a light beam scanned by the scanner unit enters the prism, a first reflecting surface for reflection in the prism of the light beam entered from that entrance surface, a second reflecting surface for reflection in the prism of a light beam reflected at that first reflecting surface and an exit surface through which a light beam reflected at that second reflecting surface leaves the prism, wherein a light beam traveling from that entrance surface toward the first reflection surface crosses a light beam traveling from the second reflecting surface toward the exit surface in the prism, may be used in the scanning optical system.

Use of such a decentered prism makes it possible to disperse power in the prism, and to reduce the amount of aberrations of the spot scanned.

According to yet another embodiment of the invention, a decentered prism comprising an entrance surface through which a light beam scanned by the scanner unit enters the prism, a first reflecting surface for reflection in the prism of the light beam entered from that entrance surface, a second reflecting surface for reflection in the prism of a light beam reflected at that first reflecting surface and an exit surface through which a light beam reflected at that second reflecting surface leaves the prism, wherein the first reflecting surface and the exit surface are defined by a single combined surface, may be used in the scanning optical system.

Such a decentered prism is preferable because the scanner can be slimed down in a direction of connecting the projection surface with the scanning mirror.

In the image display system of the invention using such a two-dimensional optical scanner as described above, an eyepiece optical system having positive power is located in the vicinity of the surface to be scanned, which is formed by the scanning optical system. This eyepiece optical system projects the image of an exit pupil (usually in the form of a virtual image) onto the vicinity of the pupil of a viewer.

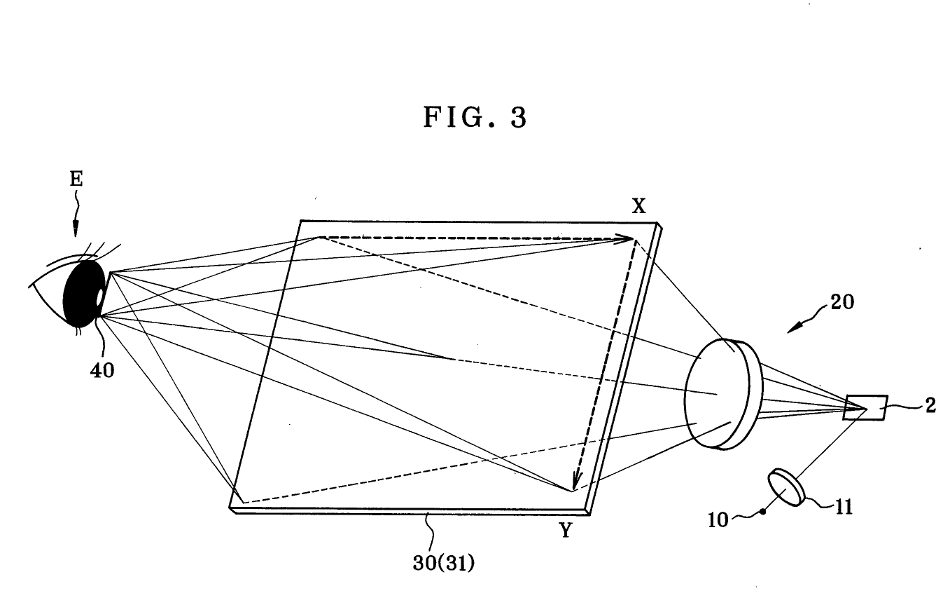

FIG. 3 is illustrative in conception of such an image display system. An eyepiece optical system 30 takes a role in projection of the exit pupil of a scanning optical system 20 onto the vicinity of the eyeball E of a viewer. By locating the eyepiece optical system 30 in the vicinity of the surface to be scanned by the scanning optical system 20, it is possible to condense a light beam leaving the scanning optical system 20 through the eyepiece optical system 30 for viewing purposes. It is thus possible to condense a substantial portion of the light beam given out of a light source 10 in the vicinity of the eyeball E of the viewer. The result is that the light from the light source 10 can effectively be used for viewing and, hence, bright images can be viewed in limited power consumption. In FIG. 3, reference numeral 11 is an illumination optical system for collimating the light from the light source 10 and entering it into a scanning mirror 2, and 40 is an image of the exit pupil of a two-dimensional optical scanner upon projected by the eyepiece optical system 30. The X-direction and Y-direction indicated at the position of the eyepiece optical system 30 stand for a main scanning direction and a sub-scanning direction, respectively. It is noted that the eyepiece optical system 30 is provided to project the exit pupil of the scanning optical system 20 onto a given position on a viewer side. As a result of bringing the eyeball E of the viewer in line with the projected position, the exit pupil of the scanning optical system will be projected onto the pupil of the viewer.

Then, by locating a diffusing surface 31 having optical diffusibility in the vicinity of the surface to be scanned, it is possible to make wide the position where images can be viewed with the eyeball E of the viewer. The diffusing surface having perfect scatter capability is preferred because of being free from illuminance fluctuations with the viewing position and constraints on the viewing direction. When power saving and size reductions are put first, however, it is preferable to use a diffusing plate having a narrow angle of diffusion because of significant improvements in the efficient of utilization of light from the light source 10. For this diffusing plate, it is acceptable to use a holographic optical element (HOE).

More preferably, the angle of diffusion by the diffusing surface 31 should be 20° or less at full width half maximum. At a lager angle of diffusion, images under observation become dark.

Even more preferably, the angle of diffusion should be 10° or greater at full width half maximum, resulting in the achievement of an easy-to-view system that enables images to be viewed with both eyes.

Preferably in this case, the diffusing plate should have an angle of diffusion of 40° or less at a full width where the intensity of light goes down to 1/10. Satisfaction of the above condition leads to reductions of wasteful losses of illumination light, i.e., efficient utilization of illumination light because light rays diffusing at an angle of at least 40° are unlikely to reach the viewer. This in turn makes it possible to utilize a small, low-output light source in the system. In this connection, the property of the diffusing surface should preferably be such that the intensity of diffused light drops sharply from full width half maximum.

At least two reflecting surfaces 31 should be provided. For instance, by locating at least two reflecting surfaces 31 in a superposed fashion along the optical axis, scintillation can be reduced even with diffusing surfaces having similar surface roughness.

The eyepiece optical system 30 used herein may be a common positive lens, a Fresnel lens of positive power, a reflecting mirror or a Fresnel reflecting mirror. The lens surfaces or reflecting surfaces of these components may be each composed of not only a rotationally symmetric surface but a decentered Fresnel lens surface, a Fresnel reflecting surface, a free-form surface or an anamorphic surface as well. These reflecting mirrors may be either of the front surface type or of the back-surface type; however, the Fresnel reflecting mirror should preferably be in the form of a back-surface mirror, a substantial back-surface mirror portion of which is defined by a Fresnel reflecting mirror.

The diffusing surface 31 having a diffusion action may also be integrally provided to at least one surface of such an eyepiece optical system 30. Alternatively, when the eyepiece optical system 30 is constructed using a Fresnel lens or a Fresnel reflecting mirror, diffusion action may be allocated to the Fresnel surface of each component.

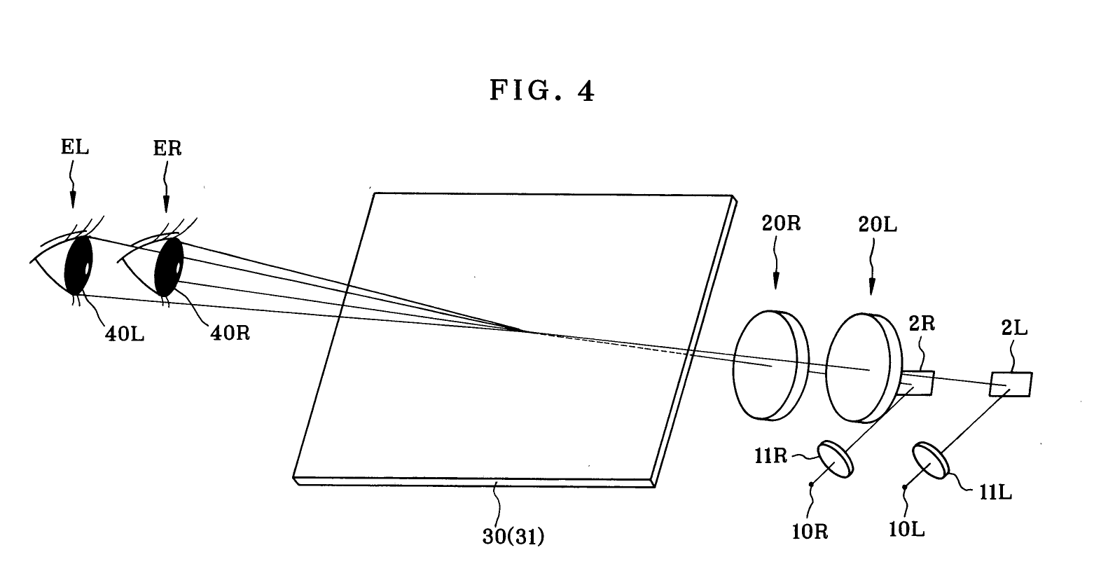

The image display system of the invention comprises a common eyepiece optical system 30, a left-eye two-dimensional scanner and a right-eye two-dimensional scanner. The eyepiece optical system 30 is located such that the exit pupil of a left-eye scanning optical system 20L is projected onto the vicinity of the pupil of the left eye EL of a viewer and the exit pupil of a right-eye scanning optical system 20R is projected onto the vicinity of the pupil of the right eye ER of the viewer, so that left and right images, for instance, images having binocular parallax are separately formed through optical scanners for the left and right eyes, whereby the viewer can see a 3D image. FIG. 4 is illustrative in conception of an image display system capable of viewing such 3D images. The image display system comprises a light source 10, an illumination optical system 11, a scanning mirror 2 and a scanning optical system 20. Reference numeral 40 stands for an image of the exit pupil of the scanning optical system 20. Each reference numeral is suffixed with “L” and “R” indicative of the left eye and the right eye, respectively, and the left and right eyeballs are indicated at EL and ER, respectively.

In the image display system capable of viewing a 3D image, the images observed with the left and right eyes are the same; however, there is a difference in the angle of viewing the respective images. In this case, a large angle of diffusion would cause cross talks; those images could be seen as a double image rather than as a stereoscopic image. Therefore, the angle of diffusion of the diffusing surface 31 located near the surface to be scanned should preferably be 8° or less at full width half maximum.

At the full width where the intensity of light decreases to 1/10, the diffusing surface should preferably have an angle of diffusion of up to 12°. Satisfaction of the above condition leads to efficient utilization of illumination light because light rays diffusing at an angle of at least 12° are unlikely to reach the viewer. In this connection, the property of the diffusing plate should preferably be such that the intensity of diffused light drops sharply from full width half maximum.

Preferably in an image display system capable of viewing bilaterally identical image with both eyes, the diffusing surface 31 located near the surface to be scanned should have an angle of diffusion of up to 20° at full width half maximum.

An angle of diffusion greater than that makes an image under observation dark. When viewing a so-called 2D image without parallax, it is desired that the same images be simultaneously observed with both eyes.

More preferably, the diffusing surface should have an angle of diffusion of at least 10° at full width half maximum. It is thus possible to obtain an easy-to-observe viewing system that enables images to be observed with both eyes.

At the full width where the intensity of light decreases to 1/10, the diffusing surface should preferably have an angle of diffusion of up to 40°. Satisfaction of the above condition leads to efficient utilization of illumination light because light rays diffusing at an angle of at least 40° are unlikely to reach the viewer. In this connection, the property of the diffusing plate should preferably be such that the intensity of diffused light drops sharply from full width half maximum.

The surface roughness of the diffusing plate 32 having the diffusing surface 31 with such angle-of-diffusion characteristics as described above is now explained.

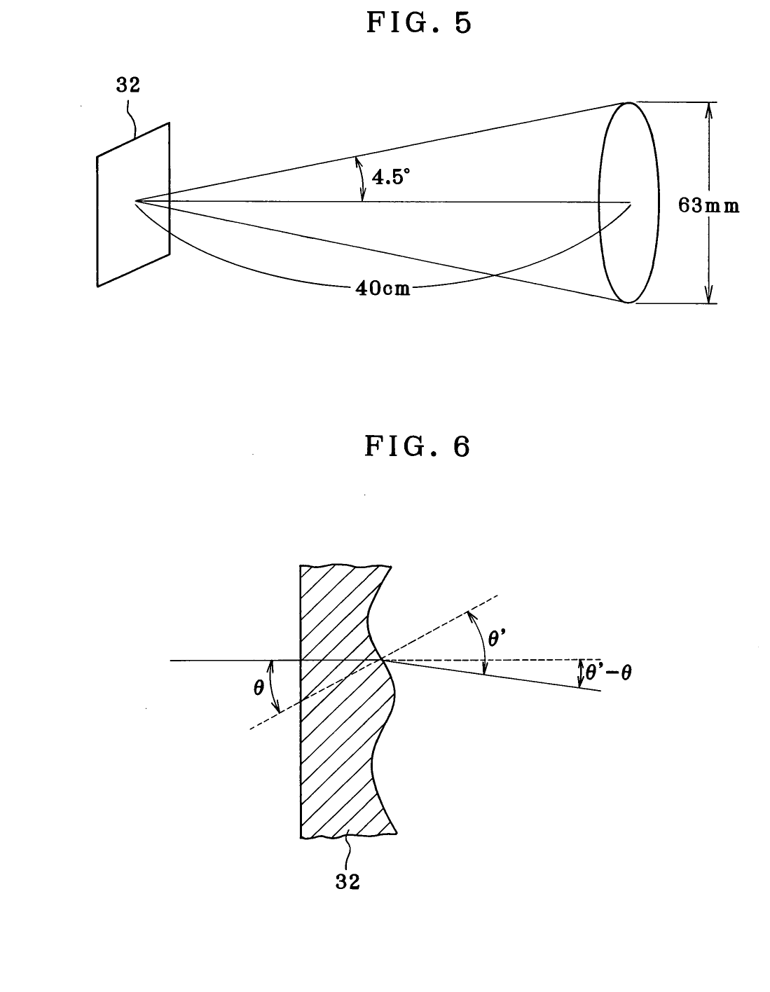

FIG. 5 is illustrative of the surface roughness of a diffusing plate 32 of the transmission type. Suppose now that a light ray is magnified to a φ63 mm size at a distance 40-cm away from the transmission type diffusing plate 32. Then, the angle of diffusion of the light ray must be 4.5° at half bandwidth. When light rays are refracted by fine pits and projections on the surface of the diffusing plate 32, the pit-and-projection is assumed to be of sine wave shape and the diffusing surface to have a refractive index of 1.5. From θ′−θ=4.5° where θ is the angle of incidence and θ′ is the angle of refraction and Snell's formula, it is then found that the angle of incidence must have a gradient of about 8.86°, as shown in FIG. 6. It follows that the maximum value of the gradient of the surface roughness must be 8.86°. Here the diffusing surface is assumed to be of smooth sine wave shape. Hence, the diffusing surface shape is expressed by

y=a×sin(2πx/T)

where a is an amplitude and T is a period. Then, the gradient of the diffusing surface becomes

(Gradient)=dy/dx=a×cos(2πx/T)×2π/T

At x=2πm (m is an integer) the gradient reaches a maximum. Hence,

(Maximum value of gradient)=a×2π/T

It is thus possible to find a/T at which the maximum value of gradient is 8.86°.

(Maximum value of gradient)=a/T×2π=8.86/180×πc=0.154

From this, one can obtain

a/T=0.0246

When the diffusing surface is of sine wave shape, the relation between the arithmetic mean roughness Ra according to JIS B0601 and a becomes

Ra/√2=a

The relation between the means pit-to-projection space Sm and the above period T becomes

Sm=T

From this, one can obtain the following result with respect to the surface roughness.

Sm=28.7Ra

In this case, the maximum gradient of the diffusing surface is 8.83°. At a refractive index of 1.5, a diffusing plate having a half angle of diffusion of 4.5° and a total angle of diffusion of 9° with respect to light rays is obtained.

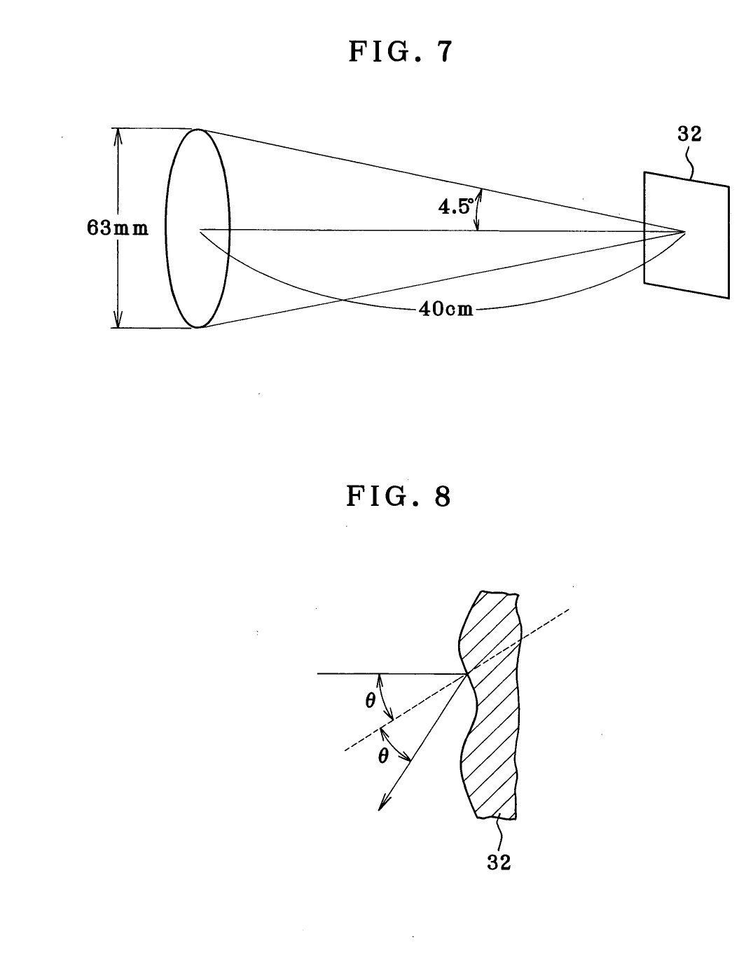

FIG. 7 is illustrative of the surface roughness of a diffusing plate 32 of the reflection type. Suppose now that a light ray is magnified to a φ63 mm size at a distance 40-cm away from the reflection type diffusing plate 32. Then, the angle of diffusion of the light ray must be 4.5° at half bandwidth. When light rays are reflected by fine pits and projections on the surface of the diffusing plate 32, the pit-and-projection is assumed to be of sine wave shape and the diffusing surface to have a refractive index of 1.5. In this case, the angles of incidence and reflection are given by θ, as shown in FIG. 8. From 2θ=4.5°, it is then found that the angle of incidence θ must have a gradient of about 2.25° that is about half of 4.5°, as shown in FIG. 8. It follows that the maximum value of the gradient of the surface roughness must be 2.25°. Here the diffusing surface is assumed to be of smooth sine wave shape. Hence, the diffusing surface shape is expressed by

y=a×sin(2πx/T)

Then, the gradient of the diffusing surface becomes

(Gradient)=dy/dx=a×cos(2πx/T)×2π/T

At x=2πm (m is an integer) the gradient reaches a maximum. Hence,

(Maximum value of gradient)=a×2π/T

It is thus possible to find a/T at which the maximum value of gradient becomes 2.25°.

(Maximum value of gradient)=a/T×2π=2.25/180×π=0.03927

From this, one can obtain

a/T=0.00625

When the diffusing surface is of sine wave shape, the relation between the arithmetic mean roughness Ra according to JIS B0601 and a becomes

Ra/√2=a

The relation between the means pit-to-projection space Sm and the above period T becomes

Sm=T

From this, one can obtain the following result with respect to the surface roughness.

Sm=113.14Ra

In this case, the maximum gradient of the diffusing surface becomes 2.25°, giving a diffusing plate 32 having a half angle of diffusion of 4.5° by reflection and a total angle of diffusion of 9°.

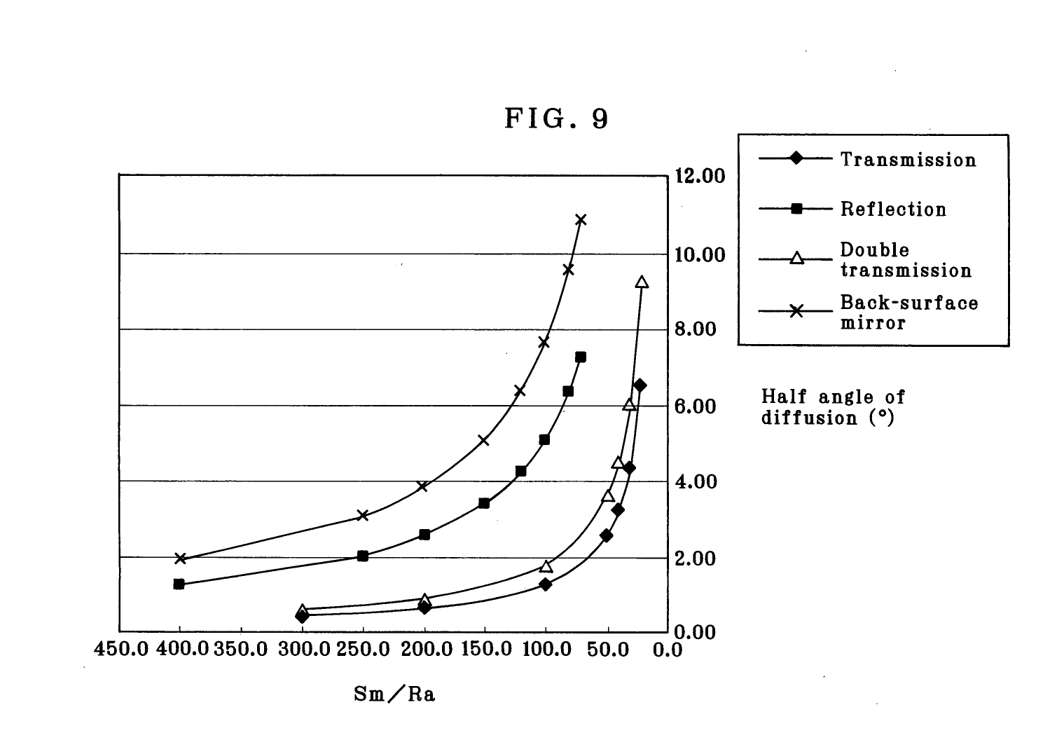

This is extended to a double-transmission type diffusing plate and a back-surface mirror type diffusing plate. The relations between Sm/Ra and the half angle of diffusion are illustrated in FIG. 9. Here the pit-and-projection surface of the diffusing surface is assumed to be approximate to the sine wave shape.

From such findings as described above, the diffusing surface 31 of the diffusing plate 32 according to the present invention should preferably have a random pit-and-projection shape in such a way as to satisfy the following conditions. This makes it possible to obtain scintillation-free, clear, bright images with a large exit pupil diameter.

With regard to the system for viewing two-dimensional (plane) images, it is preferable that:

for the single transmission type diffusing plate,

5<(Sm/Ra)×(Ep/400)<70 (1)

for the double-transmission type diffusing plate,

10<(Sm/Ra)×(Ep/400)<80 (2)

for the front-surface reflection type diffusing plate,

50<(Sm/Ra)×(Ep/400)<200 (3)

for the back-surface reflection type diffusing plate,

80<(Sm/Ra)×(Ep/400)<250 (4)

With regard to the system for viewing stereoscopic images, it is preferable that:

for the single transmission type diffusing plate,

15<(Sm/Ra)×(Ep/400)<400 (5)

for the double-transmission type diffusing plate,

25<(Sm/Ra)×(Ep/400)<500 (6)

for the front-surface reflection type diffusing plate,

80<(Sm/Ra)×(Ep/400)<1,000 (7)

for the back-surface reflection type diffusing plate,

150<(Sm/Ra)×(Ep/400)<2,000 (8)

Here Sm is a mean pit-to-projection space of the surface according to JIS B0601 (μm), Ra is a center-line mean roughness of the surface (μm), and Ep is a distance from the diffusing surface to the position of a viewer's eye (an eye point (mm)).

As the lower limits to conditions (1) to (8) are not reached, the angle of diffusion becomes too small to obtain any large pupil diameter. As the upper limits are exceeded, the diffusion of light becomes too large and so an image under observation becomes dark.

It is noted that when a Fresnel lens is used for the eyepiece optical system, it is more preferable to make the pit-and-projection shape of the diffusing surface random. A pit-and-projection shape having periodicity causes moiré fringes between the pitch of the lens and the diffusing surface, which are then superposed on an image under observation. As a result, the image becomes difficult to see.

More preferably, the following conditions should be satisfied in place of the above conditions (1) to (8).

With regard to the system for viewing two-dimensional (plane) images, it is preferable that: for the single transmission type diffusing plate,

10<(Sm/Ra)×(Ep/400)<40 (1-1)

for the double-transmission type diffusing plate,

15<(Sm/Ra)×(Ep/400)<60 (2-1)

for the front-surface reflection type diffusing plate,

70<(Sm/Ra)×(Ep/400)<150 (3-1)

for the back-surface reflection type diffusing plate,

100<(Sm/Ra)×(Ep/400)<200 (4-1)

With regard to the system for viewing stereoscopic images, it is preferable that:

for the single transmission type diffusing plate,

20<(Sm/Ra)×(Ep/400)<300 (5-1)

for the double-transmission type diffusing plate,

30<(Sm/Ra)×(Ep/400)<400 (6-1)

for the front-surface reflection type diffusing plate,

100<(Sm/Ra)×(Ep/400)<700 (7-1)

for the back-surface reflection type diffusing plate,

200<(Sm/Ra)×(Ep/400)<1,000 (8-1)

Further, the present invention should preferably satisfy condition (9) with respect to the mean pit-to-projection space of the diffusing surface of the diffusing plate.

Sm<200 μm (9)

Reference is then made to what happens when this condition (9) is not satisfied, i.e., Sm is not smaller than 200 μm. In severe cases, as the observer moves his eyes, the whole screen looks as if it blinked slightly. In other words, scintillation is visible. In less severe cases, the image lacks clearness. For instance, an image under observation looks like an image projected onto ground glass. As a result, it is impossible to view any vivid image.

More preferably,

Sm<100 μm (9-1)

Even more preferably,

Sm<50 μm (9-2)

For instance, the diffusing plate 32 of the present invention that satisfies such conditions as set forth above is disclosed in Japanese Patent Application No. 2001-370950 filed by the present applicant. This publication discloses how to fabricate diffusing plates. In the present invention, diffusing plates fabricated by such a method could be used. For instance:

(1) A diffusing plate fabricated by sandblasting. Spherical beads having limited diameters are blown onto a substrate, so that a group of concave facets or a group of facets similar to such facets or convex facets complementary to such facets can be formed on the surface of the substrate. In these groups, the facets are at random, defining a diffusing surface. In this way, the diffusing plate is fabricated.

(2) A diffusing plate fabricated by sandblasting plus copying. Spherical beads are blown onto a metal substrate to form a group of randomly arranged concave facets. This metal substrate is used as a master to copy the group of randomly arranged concave facets to a transparent substrate, so that a diffusing plate can be fabricated.

(3) A diffusing plate fabricated by sandblasting plus transfer. First, a metal substrate is provided with a layer. Then, spherical beads are blown onto the layer on the metal substrate to form a group of randomly arranged concave facets. Subsequently, the group of randomly arranged concave facets formed on the layer is similarly transferred onto the surface of the metal substrate. Finally, the metal substrate is used as a master to copy the group of randomly arranged concave facets to a transparent substrate, so that a diffusing plate can be fabricated.

(4) In the diffusing plate (1), (2) or (3), glass beads having a diameter of 0.01 mm to 2 mm are used as the spherical beads.

(5) In the diffusing plate (1), (2), (3) or (4), the spherical beads are blown at a pneumatic pressure of 0.5 to 3.0 kg/cm².

(6) In the diffusing plate according to any one of (1) to (5), the metal substrate is a brazen substrate.

(7) In the diffusing plate according to any one of (1) to (6), the metal substrate is formed of a metal whose hardness is higher than that of the spherical beads.

(8) In the diffusing plate according to any one of (2) to (7), injection molding or press molding is used to copy the group of concave facets formed on the surface of the metal substrate to the transparent substrate.

(9) A diffusing plate fabricated by a method wherein resin droplets are sprayed onto a substrate to form a group of randomly arranged convex facets, and the group of randomly arranged convex facets is similarly transferred onto the substrate side (the surface of the substrate) or a group of concave facets complementary to the group of convex facets is transferred onto the substrate side (the surface of the substrate).

In addition, the diffusing plate set forth in JP-A 9-12731, too, could be used. This diffusing substrate is fabricated by roughening one or both sides of a transparent substrate. One or both sides of the transparent substrate, for instance, could be roughened by the following methods (1) to (4).

(1) Etching; that is, one or both sides of the transparent substrate is etched.

(2) Coating or printing; that is, a resin or filler is provided on one or both side of the transparent substrate in a single layer or multilayer form by means of coating or printing. If required, a painting material or ink dispersed in water or an organic solvent is used.

(3) Electrostatic or electrodepositing coating of powders; that is, a resin or filler or their mixture is provided on one or both sides of the transparent substrate by means of electrostatic or electrodepositing coating.

(4) Film formation by extrusion molding, injection molding or the like; that is, an organic or inorganic filler together with a resin is melted with the application of heat and pressure, and the melt is formed into a film by extrusion molding, injection molding or the like. The resulting diffusing plate should preferably have a HAZE value (JIS K7105) in the range of 10 to 40.

Furthermore, the diffusing plate fabricated according to JP-A 2000-171618, too, could be used. This method of fabricating a diffusing plate comprises the steps of laminating a binder layer directly or via an additional layer on a substrate, embedding a filler into the binder layer by means of a pressurizing medium, and removing extra filler deposited onto the laminate.

Furthermore, the present invention provides a two-dimensional optical scanner comprising a light source, a scanner unit for scanning a light beam from said light source in a two-dimensional direction, and a scanning optical system including a non-rotationally symmetric surface having an action on correction of distortion upon scanning of a light beam scanned by said scanner unit, wherein:

said scanning optical system comprises a decentered prism having at least one reflecting surface as well as a symmetric surface,

said scanning optical system is located such that when the origin of a screen is defined by the point of intersection of the optical axis of said scanning optical system with the surface to be scanned, said symmetric surface substantially includes said origin of the screen, and

said scanning optical system and said scanner unit are located such that one scanning direction is substantially in line with the direction of said symmetric surface.

If the symmetric surface of the scanning optical system is designed to include the origin of the screen (the center of an image), it is then possible to bring the direction of generation of non-rotationally symmetric distortion upon scanning in line with the direction of the symmetric surface, thereby making correction for an image distortion by decentration aberration and facilitating correction of aberrations.

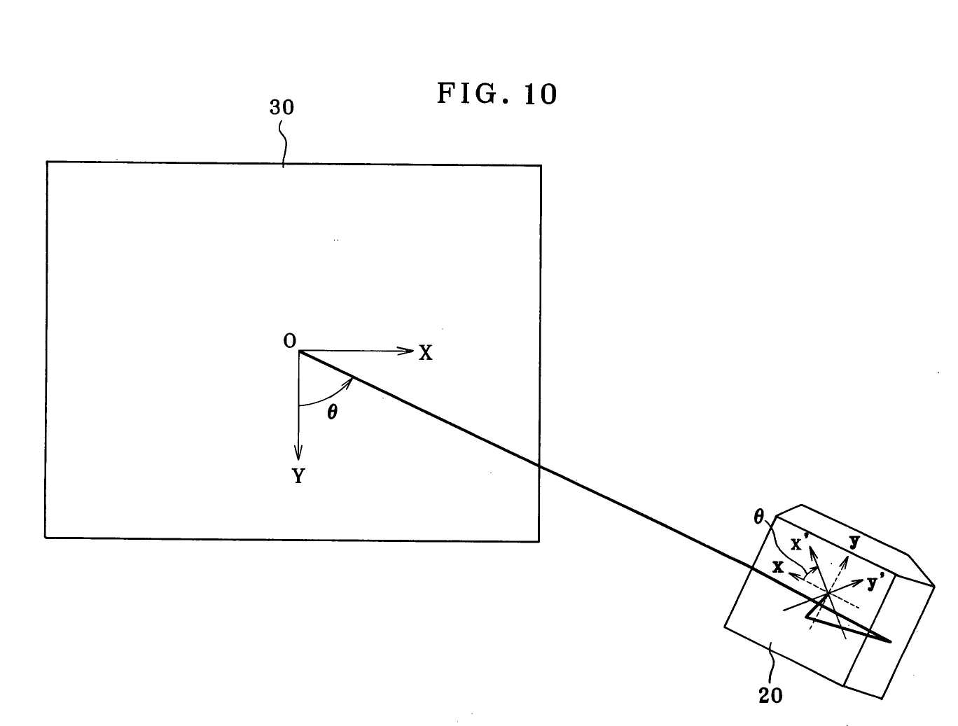

Suppose now that the scanning optical system is rotated at an angle θ around the normal to the origin O of the surface to be scanned. Referring to FIG. 10 as an example, a decentered prism 20 is rotated at an angle θ counterclockwise from a state where its symmetric surface is in line with the Y-direction. In this case, the symmetric surface of the decentered prism 20, too, is rotated at an angle θ counterclockwise with respect to the Y-direction. Correspondingly, the scanner unit is rotated at just an angle θ with respect to the decentered prism 20 with the axis of rotation defined by the optical axis of the decentered prism 20. The direction of rotation at this time is clockwise as viewed from the side of the decentered prism 20. In other words, a scanning light beam incident on the decentered prism 20 is turned from an x-x direction to an x′-x′ direction, so that scanning can be performed in the same X- and Y-directions as those before the rotation of the decentered prism 20. In such a rotation arrangement, two two-dimensional optical scanners may be provided for one eyepiece optical system 30 such that they are located on both sides of a vertical plane inclusive of the normal to the origin O of the surface to be scanned.

For instance, two scanning optical systems 20 having the same configuration may be provided to set up an image display system capable of viewing 3D images such as one shown in FIG. 4. This makes it possible to cut down the fabrication cost of scanning optical systems 20 more significantly as compared with when they are configured into different shapes, for instance, mutually plane-symmetric shapes. In this case, it is understood that the respective light sources for both two-dimensional optical scanners could be modulated by image signals so as to present separate image displays or, alternatively, they could be modulated by the same image signals so as to present the same image displays.

In the present invention, it is noted that the scanning optical system may be allowed to have negative or a very weak positive power to make the scanning angle of the scanning mirror small. Preferably, the scanning optical system should have negative power. It is noted, however, that when negative power is imparted to the scanning optical system, the illumination optical system for directing a light beam from the light source to the scanning mirror must have the capability of condensing the light beam.

The optical system used with the two-dimensional optical scanner and image display system of the invention is now explained with reference to Examples 1, 2 and 3.

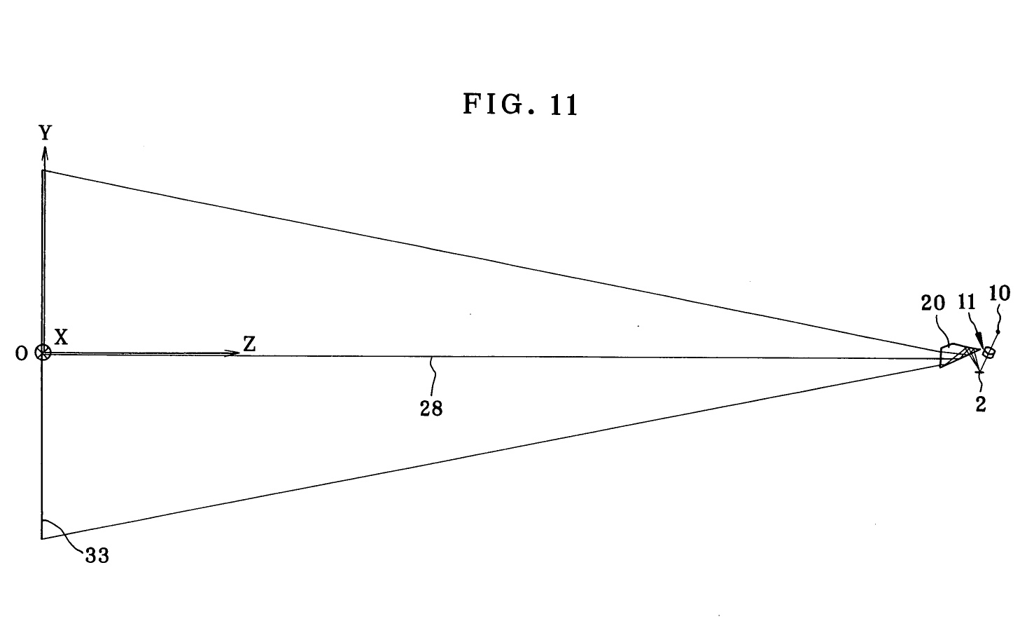

Constituting parameters of Examples 1, 2 and 3 will be given later. In the examples, ray tracing is carried out in the form of back ray tracing in order from the surface 33 to be scanned via the decentered prism 20 that forms the scanning optical system, the scanning mirror 2 and the combined surface of the decentered prism 20 forming the illumination optical system 11 toward the light source 10. As shown in FIG. 11, an axial chief ray 28 is defined by a light ray that passes through the center O of the surface 33 to be scanned and the center of a scanning mirror 2 that forms the pupil of an optical system and arrives at a light source 10. In the back ray tracing, a Z-axis is defined by a direction along the axial chief ray 28 with the origin of the decentered optical surface of a scanning optical system (decentered prism) given by the center O of the surface 33 to be scanned. The positive direction of the Z-axis is defined by a direction from the surface 33 to be scanned toward the surface of the decentered prism 20, which faces that surface 32. A Y-Z plane is defined by a plane parallel to the paper, and the positive direction of an X-axis is defined by a direction that passes through the origin and intersects at right angles with the Y-Z plane, running through the paper from its front surface. A Y-axis is defined by an axis that forms a right-hand orthogonal coordinate system with the X- and Z-axes.

For the decentered surface, there are given the amount of decentration of its apex from the center O of the origin of the optical system and the angles of inclination of its center axis around the X-, Y- and Z-axes (α, β, γ(°)). Here the amounts of decentration in the X-, Y- and Z-axis directions are referred to as X, Y and Z. The center axis is defined by the Z-axis of the aforesaid formula (a) for the free-form surface. In that case, the positive for α and β means counterclockwise rotation with respect to the positive direction of the respective axes, and the positive for γ means clockwise rotation with respect to the positive direction of the Z-axis. For α, β and γ rotation of the center axis of the surface, the center axis of the surface and its XYZ orthogonal coordinate system are first counterclockwise rotated around the X-axis by α. Then, the center axis of the rotated surface is counterclockwise rotated around the Y-axis of a new coordinate system by β while the once rotated coordinate system is counterclockwise rotated around the Y-axis by β. Then, the center axis of the twice rotated surface is clockwise rotated around the Z-axis of a new coordinate system by γ.

The surface shape of the free-form surface used herein, for instance, is defined by formula (a) in U.S. Pat. No. 6,124,989 (JP-A 2000-66105).

The aspheric surface used herein is a rotationally symmetric aspheric surface given by the following defining formula.

Z=(y²/R)/[1+{1−(1+K)y²/R²}^{1/2}]+Ay⁴+By⁶+Cy⁸+Dy¹⁰+ . . . (b)

Here Z is an optical axis (an axial chief ray) provided that the direction of propagation of light is positive, y is a direction vertical to the optical axis, R is a paraxial radius of curvature, K is a conical constant, and A, B, C, C, . . . are fourth, sixth, eighth, tenth, . . . , aspheric coefficients.

It is noted that the term concerning the free-form surface on which no data are given is zero. Refractive index is given on a d-line (587.56 nm) basis and length is given in mm.

In Examples 1, 2 and 3, the size of the surface 33 to be scanned is 162.56×121.92 mm with a numerical aperture NA of 0.002. The angles of rotation, θₓ and θ_{y}, of the scanning mirror 2 as well as the focal lengths Fₓ and F_{y} of the decentered prism forming the scanning optical system are tabulated below.

| | Ex. 1 | Ex.2 | Ex. 3 |
|---|---|---|---|
| θ_{X} | ±4.95 | ±5.93 | ±4.99 |
| θ_{y} | ±3.28 | ±2.99 | ±2.62 |
| Fₓ | −12.39 | −19.02 | 12.90 |
| F_{y} | −12.43 | −7.64 | 14.56 |

The arrangements of the optical system in the examples are now explained.

### EXAMPLE 1

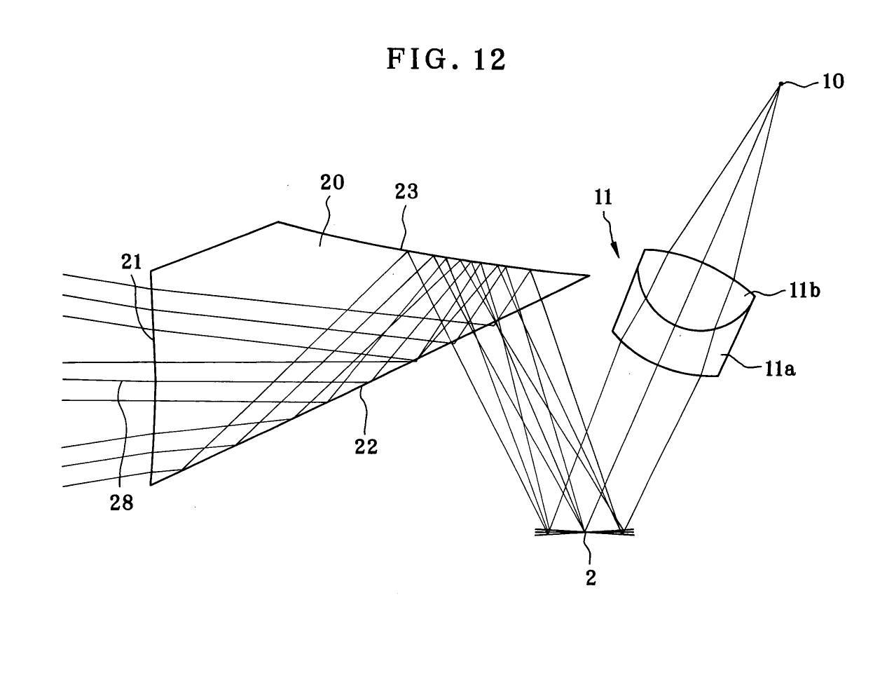

The optical system of Example 1 is shown in FIGS. 11 and 12. FIG. 11 is an optical path diagram in a Y-Z section for the whole optical system from the surface 33 to be scanned to a light source 10, and FIG. 12 is an optical path diagram in the Y-Z section for a substantial part thereof. In this example, the scanning optical system is made up of a decentered prism 20 located in opposition to the surface 33 to be scanned. As viewed in order of back ray tracing, the decentered prism 20 comprises a first surface 21 providing an exit surface, a second surface 22 providing a combined entrance and second reflecting surface, and a third surface 23 providing a first reflecting surface. There is then a scanning mirror 2 for a scanner unit 1 (FIG. 1) that faces the second surface 22 of the decentered prism 20. On the entrance side (the exit surface as viewed in back ray tracing) of the scanning mirror 2, there is provided an illumination optical system 11 having positive power and made up of a doublet consisting of a negative meniscus lens 11a concave on the side of the light source 10 and a double-convex positive lens 11b. The light source 10 is positioned on the side of the illumination optical system 11 that faces away from the scanning mirror 2. A light beam from the light source 10 is incident on the scanning mirror 2 upon collimated into a substantially parallel light beam through the illumination optical system 11. A light beam reflected and scanned at the scanning mirror 2 that rotates around two orthogonal axes enters the prism via the second surface 22 of the decentered prism 20, whereupon the light beam is internally reflected at the third surface 23 and then totally reflected at the second surface 22, leaving the prism via the first surface 21. Leaving the decentered prism 20, the light beam forms scanning lines on the surface 33 to be scanned, which is located at a distance.

In the decentered prism 20 according to the instant example, the entrance surface also serves as the second reflecting surface, so that the angle that the light beam incident on the scanning mirror 2 subtends the light beam reflected from the scanning mirror 2 can be made small, resulting in the achievement of a layout where the light beam scanned by the scanning mirror 2 has little or no distortion upon scanning.

In this example, the first surface 21 of the decentered prism 20 is made up of a spherical (concave) surface, and the second surface 22 and third surface 23 are each built up of a free-form surface. The second and third surfaces 22 and 23 are decentered in the Y-Z plane, and the lenses 11a and 11b are each made up of a spherical surface.

### EXAMPLE 2

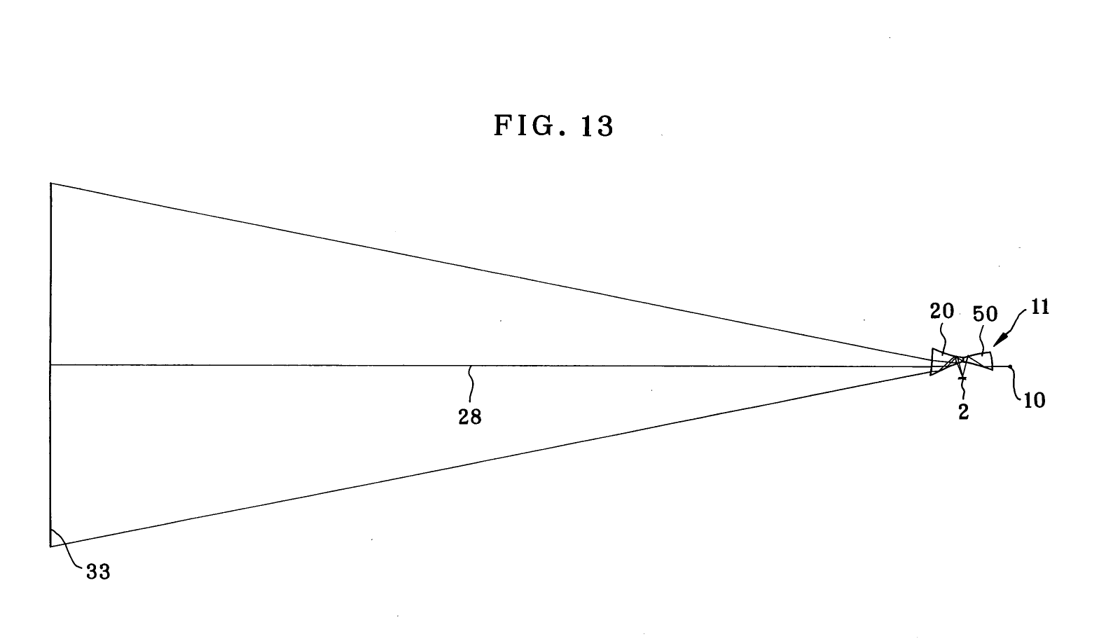

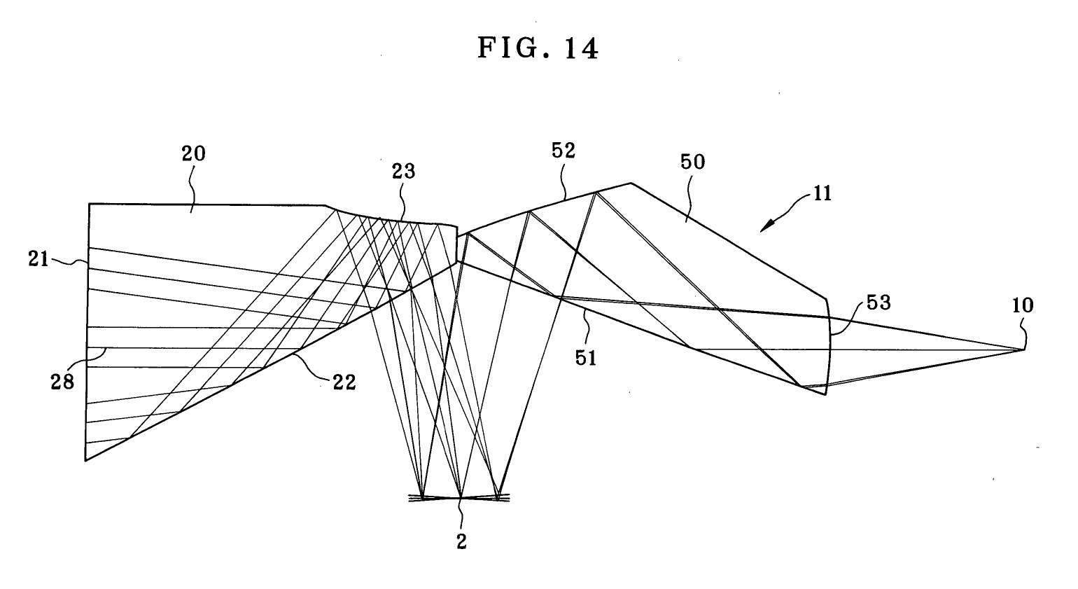

The optical system of Example 2 is shown in FIGS. 13 and 14. FIG. 13 is an optical path diagram in a Y-Z section for the whole optical system from the surface 33 to be scanned to a light source 10, and FIG. 14 is an optical path diagram in the Y-Z section for a substantial part thereof. In this example, the scanning optical system is made up of a decentered prism 20 located in opposition to the surface 33 to be scanned. As viewed in order of back ray tracing, the decentered prism 20 has a first surface 21 providing an exit surface, a second surface 22 providing a combined entrance and second reflecting surface, and a third surface 23 providing a first reflecting surface. There is then located a scanning mirror 2 for a scanner unit 1 (FIG. 1) that faces the second surface 22 of the decentered prism 20. On the entrance side (the exit surface as viewed in back ray tracing) of the scanning mirror 2, another decentered prism 50 is provided as an illumination optical system 11 having positive power. This decentered prism 50 is made up of, in the order of back ray tracing, a first surface 51 that provides a combined exit and first reflecting surface, a second surface 52 that provides a second reflecting surface and a third surface 53 that provides an entrance surface. Entering the decentered prism 50 forming the illumination optical system 11 from the third surface 53, a light beam from the light source 10 is totally reflected at the first surface 51 and internally reflected at the second surface 52, transmitting through the first surface 51 where it is converted into a substantially parallel light beam for incidence on the scanning mirror 2. A light beam reflected and scanned at the scanning mirror 2 that rotates around two orthogonal axes enters the prism via the second surface 22 of the decentered prism 20, whereupon the light beam is internally reflected at the third surface 23 and then totally reflected at the second surface 22, leaving the prism via the first surface 21. Leaving the decentered prism 20, the light beam forms scanning lines on the surface 33 to be scanned, which is located at a distance.

In the decentered prism 20 according to the instant example, the entrance surface also serves as the second reflecting surface, so that the angle that the light beam incident on the scanning mirror 2 subtends the light beam reflected from the scanning mirror 2 can be made small. In the decentered prism 50, too, the exit surface also serves as the first reflecting surface, so that the angle that the light beam incident on the scanning mirror 2 subtends the light beam reflected from the scanning mirror 2 can be made small, resulting in the achievement of a layout where the light beam scanned by the scanning mirror 2 has little or no distortion upon scanning.

In this example, the first surface 21 of the decentered prism 20 is made up of a spherical (concave) surface, and the second and third surfaces 22 and 23 are each built up of a free-form surface and decentered in the Y-Z plane. The third surface 53 of the decentered prism 50 is made up of a spherical (convex) surface, and the first and second surfaces 51 and 52 are each composed of a free-form surface.

### EXAMPLE 3

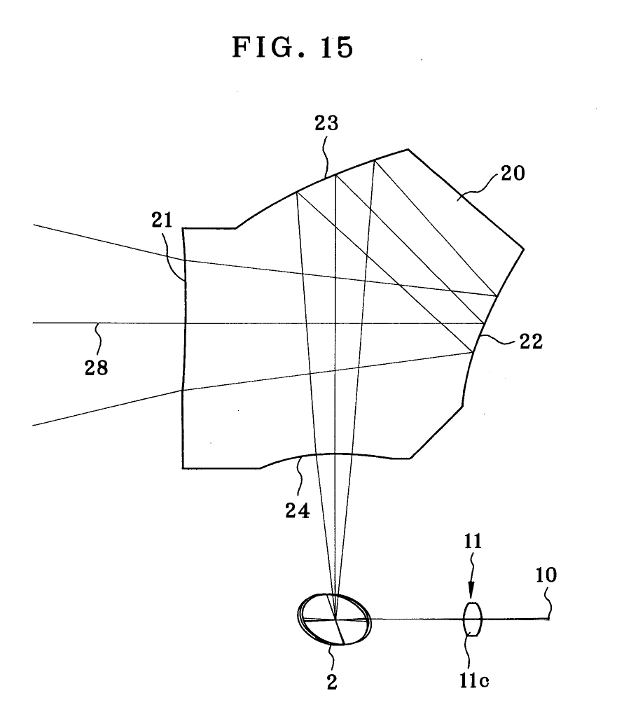

The optical system of Example 3 is shown in FIG. 15. FIG. 15 is an optical path diagram for a substantial part of the optical system from the surface 33 to be scanned to a light source 10 upon projected onto a Y-Z plane. In this example, the scanning optical system is made up of a decentered prism 20 located in opposition to the surface 33 to be scanned. As viewed in order of back ray tracing, the decentered prism 20 has a first surface 21 providing an exit surface, a second surface 22 providing a second reflecting surface, a third surface 23 providing a first reflecting surface, a fourth surface 24 providing an entrance surface and a fifth surface 25 providing the entrance surface of an illumination optical system. There is then a scanning mirror 2 for a scanner unit 1 (FIG. 1) that faces the second surface 22 of the decentered prism 20. On the entrance side (the exit surface as viewed in back ray tracing), there is provided an illumination optical system 11 having positive power and comprising a plano-convex positive lens 11c with a plane directed to the side of the light source 10. The light source 10 is positioned on the side of the illumination optical system 11 that faces away from the scanning mirror 2. A light beam from the light source 10 is incident on the scanning mirror 2 upon collimated into a substantially parallel light beam through the illumination optical system 11. A light beam reflected and scanned at the scanning mirror 2 that rotates around two orthogonal axes enters the decentered prism 20 via the second surface 22 of the decentered prism, whereupon the light beam is internally reflected at the third surface 23 and then totally reflected at the second surface 22, leaving the prism via the first surface 21. Leaving the decentered prism 20, the light beam forms scanning lines on the surface 33 to be scanned, which is located at a distance.

In this example, the decentered prism 20 is designed such that a light from the fourth surface 24 toward the third surface 23 crosses a light beam from the second surface 22 to the first surface 21 in the prism. The first to fourth surfaces 21, 22, 23 and 24 are each made up of a free-form surface, and the first, second, third and fourth surfaces 21, 22, 23 and 24 are three-dimensionally decentered with no symmetric surface. The plane-convex positive lens 11c has a convex surface composed of an aspheric surface.

Tabulated below are numerical data on each example, wherein “FFS”, “ASS” and “RE” stand for a free-form surface, an aspheric surface and a reflecting surface, respectively. The “stop surface” and “image plane” correspond to the location of the scanning mirror 2 and the position of the light source 10, respectively.

### EXAMPLE 1

| Surface | Radius of | Surface | Displacement | Refractive | Abbe's |
|---|---|---|---|---|---|
| No. | curvature | separation | and tilt | index | No. |
| Object | ∞ | | | | |
| plane | | | | | |
| 1 | −27.92 | | (1) | 1.5163 | 64.1 |
| 2 | FFS\mathring{1} (RE) | | (2) | 1.5163 | 64.1 |
| 3 | FFS\mathring{2} (RE) | | (3) | 1.5163 | 64.1 |
| 4 | FFS\mathring{1} | | (2) | | |
| 5 | ∞ (Stop, RE) | | (4) | | |
| 6 | 3.22 | | (5) | 1.7518 | 31.2 |
| 7 | 1.57 | | (6) | 1.5163 | 64.1 |
| 8 | −4.16 | | (7) | | |
| Image | ∞ | | (8) | | |
| plane | | | | | |

FFS1

| | |
|---|---|
| C₄ −1.1308 × 10⁻² | C₆ −5.0132 × 10⁻⁴ |

FFS2

| | |
|---|---|
| C₄ −1.8737 × 10⁻² | C₆ −8.9020 × 10⁻³ |

Displacement and tilt(1)

| | | | | | |
|---|---|---|---|---|---|
| X | 0.00 | Y | 0.00 | Z | 300.00 |
| α | 0.00 | β | 0.00 | γ | 0.00 |

Displacement and tilt(2)

| | | | | | |
|---|---|---|---|---|---|
| X | 0.00 | Y | 0.00 | Z | 305.87 |
| α | −65.15 | β | 0.00 | γ | 0.00 |

Displacement and tilt(3)

| | | | | | |
|---|---|---|---|---|---|
| X | 0.00 | Y | 3.22 | Z | 308.61 |
| α | −98.23 | β | 0.00 | γ | 0.00 |

Displacement and tilt(4)

| | | | | | |
|---|---|---|---|---|---|
| X | 0.00 | Y | −4.00 | Z | 311.72 |
| α | −90.00 | β | 0.00 | γ | 0.00 |

Displacement and tilt(5)

| | | | | | |
|---|---|---|---|---|---|
| X | 0.00 | Y | 0.60 | Z | 313.69 |
| α | 66.81 | β | 0.00 | γ | 0.00 |

Displacement and tilt(6)

| | | | | | |
|---|---|---|---|---|---|
| X | 0.00 | Y | 1.52 | Z | 314.09 |
| α | 66.81 | β | 0.00 | γ | 0.00 |

Displacement and tilt(7)

| | | | | | |
|---|---|---|---|---|---|
| X | 0.00 | Y | 3.35 | Z | 314.88 |
| α | 66.81 | β | 0.00 | γ | 0.00 |

Displacement and tilt(8)

| | | | | | |
|---|---|---|---|---|---|
| X | 0.00 | Y | 7.95 | Z | 316.84 |
| α | 66.81 | β | 0.00 | γ | 0.00 |

### EXAMPLE 2

| Surface | Radius of | Surface | Displacement | Refractive | Abbe's |
|---|---|---|---|---|---|
| No. | curvature | separation | and tilt | index | No. |
| Object | ∞ | | | | |
| plane | | | | | |
| 1 | 268.19 | | (1) | 1.5163 | 64.1 |
| 2 | FFS\mathring{1} (RE) | | (2) | 1.5163 | 64.1 |
| 3 | FFS\mathring{2} (RE) | | (3) | 1.5163 | 64.1 |
| 4 | FFS\mathring{1} | | (2) | | |
| 5 | ∞ (Stop, RE) | | (4) | | |
| 6 | FFS\mathring{3} | | (5) | 1.5163 | 64.1 |
| 7 | FFS\mathring{4} (RE) | | (6) | 1.5163 | 64.1 |
| 8 | FFS\mathring{3} (RE) | | (5) | 1.5163 | 64.1 |
| 9 | 7.82 | | (7) | | |
| Image | ∞ | | (8) | | |
| plane | | | | | |

FFS1

| | |
|---|---|
| C₄ −1.0549 × 10⁻² | C₆ −4.1489 × 10⁻⁴ |

FFS2

| | |
|---|---|
| C₄ −1.8542 × 10⁻² | C₆ −2.0673 × 10⁻² |

FFS3

| | | |
|---|---|---|
| C₄ 9.5346 × 10⁻³ | C₆ −9.5275 × 10⁻⁴ | C₈ −1.1963 × 10⁻³ |
| C₁₀ −9.4802 × 10⁻⁵ | | |

FFS4

| | | |
|---|---|---|
| C₄ 2.5428 × 10⁻² | C₆ 1.5243 × 10⁻² | C₈ −6.3775 × 10⁻⁴ |
| C₁₀ −7.9996 × 10⁻⁵ | | |

Displacement and tilt(1)

| | | | | | |
|---|---|---|---|---|---|
| X | 0.00 | Y | 0.00 | Z | 300.00 |
| α | 0.00 | β | 0.00 | γ | 0.00 |

Displacement and tilt(2)

| | | | | | |
|---|---|---|---|---|---|
| X | 0.00 | Y | 0.00 | Z | 305.78 |
| α | −62.19 | β | 0.00 | γ | 0.00 |

Displacement and tilt(3)

| | | | | | |
|---|---|---|---|---|---|
| X | 0.00 | Y | 3.42 | Z | 308.11 |
| α | −97.92 | β | 0.00 | γ | 0.00 |

Displacement and tilt(4)

| | | | | | |
|---|---|---|---|---|---|
| X | 0.00 | Y | −4.00 | Z | 310.08 |
| α | −90.00 | β | 0.00 | γ | 0.00 |

Displacement and tilt(5)

| | | | | | |
|---|---|---|---|---|---|
| X | 0.00 | Y | 0.00 | Z | 316.47 |
| α | −109.57 | β | 0.00 | γ | 0.00 |

Displacement and tilt(6)

| | | | | | |
|---|---|---|---|---|---|
| X | 0.00 | Y | 3.64 | Z | 311.99 |
| α | −72.39 | β | 0.00 | γ | 0.00 |

Displacement and tilt(7)

| | | | | | |
|---|---|---|---|---|---|
| X | 0.00 | Y | 0.00 | Z | 320.08 |
| α | −180.00 | β | 0.00 | γ | 0.00 |

Displacement and tilt(8)

| | | | | | |
|---|---|---|---|---|---|
| X | 0.00 | Y | 0.00 | Z | 325.08 |
| α | 0.00 | β | 0.00 | γ | 0.00 |

### EXAMPLE 3

| Surface | Radius of | Surface | Displacement | Refractive | Abbe's |
|---|---|---|---|---|---|
| No. | curvature | separation | and tilt | index | No. |
| Object | ∞ | | | | |
| plane | | | | | |
| 1 | FFS\mathring{1} | | (1) | 1.5163 | 64.1 |
| 2 | FFS\mathring{2} (RE) | | (2) | 1.5163 | 64.1 |
| 3 | FFS\mathring{3} (RE) | | (3) | 1.5163 | 64.1 |
| 4 | FFS\mathring{4} | | (4) | | |
| 5 | ∞ (Stop, RE) | | (5) | | |
| 6 | ASS\mathring{1} | | (6) | 1.5163 | 64.1 |
| 7 | ∞ | | (7) | | |
| Image | ∞ | | (8) | | |
| plane | | | | | |

ASS1

R −5.16
K 0.0000
A 1.1267 × 10⁻³
B −1.2544 × 10⁻²

FFS1

| | | |
|---|---|---|
| C₄ −7.1515 × 10⁻² | C₆ −1.4245 × 10⁻² | C₈ 7.9919 × 10⁻³ |
| C₁₀ 2.0305 × 10⁻³ | | |

FFS2

| | | |
|---|---|---|
| C₄ 4.9459 × 10⁻³ | C₆ 5.0516 × 10⁻² | C₈ 1.5603 × 10⁻³ |
| C₁₀ −4.1813 × 10⁻³ | C₁₁ −1.3847 × 10⁻⁴ | C₁₃ 4.3619 × 10⁻⁴ |
| C₁₅ 5.2999 × 10⁻⁴ | | |

FFS3

| | | |
|---|---|---|
| C₄ −3.7641 × 10⁻⁴ | C₆ 2.6864 × 10⁻² | C₈ −1.2701 × 10⁻⁴ |
| C₁₀ −7.6401 × 10⁻⁴ | C₁₁ −2.5134 × 10⁻⁴ | C₁₃ 5.3179 × 10⁻⁵ |
| C₁₅ −2.7318 × 10⁻⁵ | | |

FFS4

| | | |
|---|---|---|
| C₄ −7.7505 × 10⁻² | C₆ −2.6903 × 10⁻³ | C₈ −1.1335 × 10⁻³ |
| C₁₀ −1.0568 × 10⁻² | | |

Displacement and tilt(1)

| | | | | | |
|---|---|---|---|---|---|
| X | −150.00 | Y | −45.12 | Z | 255.86 |
| α | −10.00 | β | 30.00 | γ | −67.56 |

Displacement and tilt(2)

| | | | | | |
|---|---|---|---|---|---|
| X | −154.00 | Y | −46.32 | Z | 262. 68 |
| α | −23.19 | β | 50.20 | γ | −58.91 |

Displacement and tilt(3)

| | | | | | |
|---|---|---|---|---|---|
| X | −148.80 | Y | −44.53 | Z | 261.36 |
| α | −115.16 | β | 68.57 | γ | 25.21 |

Displacement and tilt(4)

| | | | | | |
|---|---|---|---|---|---|
| X | −155.20 | Y | −46.90 | Z | 257.19 |
| α | −150.44 | β | 53.17 | γ | 56.53 |

Displacement and tilt(5)

| | | | | | |
|---|---|---|---|---|---|
| X | −158.40 | Y | −48.08 | Z | 255.10 |
| α | −124.51 | β | 13.16 | γ | 111.76 |

Displacement and tilt(6)

| | | | | | |
|---|---|---|---|---|---|
| X | −163.19 | Y | −39.69 | Z | 257.69 |
| α | −107.14 | β | −28.59 | γ | 114.27 |

Displacement and tilt(7)

| | | | | | |
|---|---|---|---|---|---|
| X | −164.15 | Y | −38.01 | Z | 258.21 |
| α | −107.14 | β | −28.59 | γ | 114.27 |

Displacement and tilt(8)

| | | | | | |
|---|---|---|---|---|---|
| X | −166.57 | Y | −33.76 | Z | 259.52 |
| α | −107.14 | β | −28.59 | γ | 114.27 |

The two-dimensional scanner and image display system of the invention as described above may be embodied as follows.

(1) A two-dimensional optical scanner comprising a light source, a scanner unit of a gimbal structure for scanning a light beam from said light source in a two-dimension direction, and a scanning optical system having a non-rotationally symmetric surface having an action on correcting a distortion upon scanning of a light beam scanned by said scanner unit, characterized in that:

said scanning optical system comprises a decentered prism having an entrance surface through which a light beam scanned by said scanner unit enters said prism, at least one reflecting surface for allowing a light beam entered from said entrance surface in said prism to be reflected in said prism and an exit surface through which a light beam reflected at said reflecting surface leaves said prism, wherein at least one of said entrance surface, said reflecting surface and said exit surface comprises a non-rotationally symmetric surface.

(2) The two-dimensional optical scanner of (1) above, characterized in that a light-emitting diode or a laser diode is used as said light source.

(3) The two-dimensional optical scanner of (1) or (2) above, characterized in that a light source comprising three or more colors including R, G and B is used as said light source.

(4) The two-dimensional optical scanner of any one of (1) to (3) above, characterized in that the light beam from said light source is incident on said scanning mirror upon collimation by an optical element having positive power.

(5) The two-dimensional optical scanner of any one of (1) to (4) above, characterized in that at least one of said non-rotationally symmetric surfaces is composed of a transmitting surface.

(6) The two-dimensional optical scanner of any one of (1) to (4) above, characterized in that at least one of said non-rotationally symmetric surfaces is composed of a reflecting surface.

(7) The two-dimensional optical scanner of any one of (1) to (4) above, characterized in that at least two of said non-rotationally symmetric surfaces are each composed of a reflecting surface.

(8) The two-dimensional optical scanner of any one of (1) to (7) above, characterized in that said decentered prism comprises an entrance surface through which the light beam scanned by said scanner unit enters the said prism, a first reflecting surface for reflection in said prism of the light beam entered from said entrance surface in said prism, a second reflecting surface for reflection in said prism of a light beam reflected at said first reflecting surface and an exit surface through which a light beam reflected at said second reflecting surface leaves said prism, wherein said entrance surface and said second reflecting surface are defined by a single surface.

(9) The two-dimensional optical scanner of any one of (1) to (7) above, characterized in that said decentered prism comprises an entrance surface through which the light beam scanned by said scanner unit enters the said prism, a first reflecting surface for reflection in said prism of the light beam entered from said entrance surface in said prism, a second reflecting surface for reflection in said prism of a light beam reflected at said first reflecting surface and an exit surface through which a light beam reflected at said second reflecting surface leaves said prism, and is designed such that a light beam from said entrance surface toward said first reflecting surface and a light beam from said second reflecting surface toward said exit surface cross in said prism.

(10) The two-dimensional optical scanner of any one of (1) to (7) above, characterized in that said decentered prism comprises an entrance surface through which the light beam scanned by said scanner unit enters the said prism, a first reflecting surface for reflection in said prism of the light beam entered from said entrance surface in said prism, a second reflecting surface for reflection in said prism of a light beam reflected at said first reflecting surface and an exit surface through which a light beam reflected at said second reflecting surface leaves said prism, wherein said first reflecting surface and said exit surface are defined by a single surface.

(11) An image display system comprising a light source, a scanner unit of a gimbal structure for scanning a light beam from said light source in a two-dimension direction, a scanning optical system having a non-rotationally symmetric surface having an action on correcting a distortion upon scanning of a light beam scanned by said scanner unit, and an eyepiece optical system located in the vicinity of the surface to be scanned, which is formed by said scanning optical system, for projecting an exit pupil of said scanning optical system onto the vicinity of a viewer's pupil and having positive power, characterized in that:

said scanning optical system comprises a decentered prism having an entrance surface through which a light beam scanned by said scanner unit enters said prism, at least one reflecting surface for allowing a light beam entered from said entrance surface in said prism to be reflected in said prism and an exit surface through which a light beam reflected at said reflecting surface leaves said prism, wherein at least one of said entrance surface, said reflecting surface and said exit surface comprises a non-rotationally symmetric surface.

(12) The image display system of (11) above, characterized in that a diffusing surface having optical diffusibility is located in the vicinity of said surface to be scanned.

(13) The image display system of (12) above, characterized in that at least two diffusing surfaces are provided.

(14) The image display system of (12) or (13) above, characterized in that the angle of diffusion by said diffusing surface has a full width half maximum of 20° or less.

(15) The image display system of any one of (12) to (14) above, characterized in that the angle of diffusion by said diffusing surface is 40° or less at a full width where light intensity goes down to 1/10.

(16) The image display system of (12) above, characterized in that a pair of left and right two-dimensional optical scanners, each comprising said light source, said scanner unit and said scanning optical system, are provided with respect to said eyepiece optical system.

(17) The image display system of (16) above, characterized in that bilaterally identical images are displayed by said left and right two-dimensional optical scanners, and the angle of diffusion by said diffusing surface has a full width half maximum of 20° or less.

(18) The image display system of (16) or (17) above, characterized in that bilaterally identical images are displayed by said left and right two-dimensional optical scanners, and the angle of diffusion by said diffusing surface is 40° or less at a full width where light intensity goes down to 1/10.

(19) The image display system of (16) above, characterized in that bilaterally identical images are displayed by said left and right two-dimensional optical scanners, and the angle of diffusion by said diffusing surface has a full width half maximum of 8° or less.

(20) The image display system of (16) or (19) above, characterized in that bilaterally identical images are displayed by said left and right two-dimensional optical scanners, and the angle of diffusion by said diffusing surface is 12° or less at a full width where light intensity goes down to 1/10.

(21) The image display system of (17) or (18) above, characterized by satisfying the following conditions:

for a single transmission type diffusing plate,

5<(Sm/Ra)×(Ep/400)<70 (1)

for a double-transmission type diffusing plate,

10<(Sm/Ra)×(Ep/400)<80 (2)

for a front-surface reflection type diffusing plate,

50<(Sm/Ra)×(Ep/400)<200 (3)

for a back-surface reflection type diffusing plate,

80<(Sm/Ra)×(Ep/400)<250 (4)

where Sm is a mean pit-to-projection space of the surface according to JIS B0601 (μm), Ra is a center-line mean roughness of the surface (μm), and Ep is a distance (mm) from the diffusing surface of the diffusing plate to the position of a viewer's eye.

(22) The image display system of (19) or (20) above, characterized by satisfying the following conditions:

for a single transmission type diffusing plate,

15<(Sm/Ra)×(Ep/400)<400 (5)

for a double-transmission type diffusing plate,

25<(Sm/Ra)×(Ep/400)<500 (6)

for a front-surface reflection type diffusing plate,

80<(Sm/Ra)×(Ep/400)<1,000 (7)

for a back-surface reflection type diffusing plate,

150<(Sm/Ra)×(Ep/400)<2,000 (8)

where Sm is a mean pit-to-projection space of the surface according to JIS B0601 (μm), Ra is a center-line mean roughness of the surface (μm), and Ep is a distance (mm) from the diffusing surface of the diffusing plate to the position of a viewer's eye.

(23) The image display system of (21) or (22) above, characterized by satisfying the following condition:

Sm<200 μm (9)

(24) The image display system of any one of (11) to (23) above, characterized in that said eyepiece optical system comprises a Fresnel lens.

(25) The image display system of any one of (11) to (23) above, characterized in that said eyepiece optical system comprises a Fresnel reflecting mirror.

(26) The image display system of any one of (11) to (25) above, characterized in that said eyepiece optical system comprises a Fresnel back-surface mirror.

(27) The image display system of any one of (12) to (26) above, characterized in that said diffusing surface is provided on at least one surface of said eyepiece optical system.

As can be seen from what has been described, the present invention can provide a compact two-dimensional optical scanner with reduced distortions upon scanning, which is constructed using a scanning mirror of gimbal structure as well as an image display system using the same.

What we claim is:

1. A two-dimensional optical scanner, comprising:
a light source,
a scanner unit for scanning a light beam from said light source on a surface to be scanned in a two-dimensional direction, and
a scanning optical system having a non-rotationally symmetric surface, wherein:
said scanner unit has a gimbal structure, and
said scanning optical system comprises a decentered prism comprising an entrance surface through which a light beam scanned by said scanner unit enters said prism,
at least one reflecting surface for allowing a light beam entered from said entrance surface in said prism to be reflected in said prism, and
an exit surface through which a light beam reflected at said second reflecting surface leaves said prism, wherein at least one of said entrance surface, said reflecting surface and said exit surface comprises a non-rotationally symmetric surface.

2. The two-dimensional optical scanner according to claim 1, wherein:
said light source is a light-emitting diode or a laser diode.

3. The two-dimensional optical scanner according to claim 1 or 2, wherein:
said light source includes light of at least R, G and B wavelengths.

4. The two-dimensional optical scanner according to claim 1, which further comprises:
an optical element having positive power, which is interposed between said optical system and said scanner unit for collimation of a light beam from said light source.

5. The two-dimensional optical scanner according to claim 1, wherein:
at least one of said non-rotationally symmetric surfaces is a transmitting surface.

6. The two-dimensional optical scanner according to claim 1, wherein:
at least one of said non-rotationally symmetric surfaces is a reflecting surface.

7. The two-dimensional optical scanner according to claim 1, wherein:
at least two of said non-rotationally symmetric surfaces are reflecting surfaces.

8. The two-dimensional optical scanner according to claim 1, wherein:
said decentered prism comprises:
a first reflecting surface for reflection in said prism of a light beam entered from said entrance surface in said prism, and
a second reflecting surface for reflection in said prism of a light beam reflected at said first reflecting surface,
wherein said entrance surface and said second reflecting surface are made up of an identical surface.

9. The two-dimensional optical scanner according to claim 1, wherein:
said decentered prism comprises:
a first reflecting surface for reflection in said prism of a light beam entered from said entrance surface in said prism, and
a second reflecting surface for reflection in said prism of a light beam reflected at said first reflecting surface, and
said decentered prism is designed such that a light beam from said entrance surface toward said first reflecting surface and a light beam from said second reflecting surface toward said exit surface cross in said prism.

10. The two-dimensional optical scanner according to claim 1, wherein:
said decentered prism comprises:
a first reflecting surface for reflection in said prism of a light beam entered from said entrance surface in said prism, and
a second reflecting surface for reflection in said prism of a light beam reflected at said first reflecting surface,
wherein said exit surface and said second reflecting surface are made up of an identical surface.

11. An image display system, comprising:
a light source,
a scanner unit for scanning a light beam from said light source in a two-dimension direction,
a scanning optical system having a non-rotationally symmetric surface, and
an eyepiece optical system located near a surface to be scanned and having positive power, wherein:
said scanner unit has a gimbal structure, and
said scanning optical system comprises a decentered prism comprising:
an entrance surface through which a light beam scanned by said scanner unit enters said prism,
at least one reflecting surface for allowing a light beam entered from said entrance surface in said prism to be reflected in said prism, and
an exit surface through which a light beam reflected at said second reflecting surface leaves said prism,
wherein at least one of said entrance surface, said reflecting surface and said exit surface comprises a non-rotationally symmetric surface.

12. The image display system according to claim 11, wherein a diffusing surface having optical diffusibility is located near said surface to be scanned.

13. The image display system according to claim 12, wherein at least two diffusing surfaces are provided.

14. The image display system according to claim 12, wherein said diffusing surface has an angle of diffusion of 20° or less at full width half maximum where light intensity goes down to ½.

15. The image display system according to claim 12, wherein said diffusing surface has an angle of diffusion of 40° or less at a full width where light intensity goes down to 1/10.

16. The image display system according to claim 12, wherein a pair of left and right two-dimensional optical scanners, each comprising said light source, said scanner unit and said scanning optical system, are provided with respect to said eyepiece optical system.

17. The image display system according to claim 16, wherein said pair of left and right two-dimensional optical scanners display an identical image.

18. The image display system according to claim 16, wherein said pair of left and right two-dimensional optical scanners display different images.

19. The image display system according to claim 18, wherein said diffusing surface has an angle of diffusion of 8° or less at full width half maximum.

20. The image display system according to claim 18, wherein said diffusing surface has an angle of diffusion of 12° or less at a full width where light intensity goes down to 1/10.

21. The image display system according to claim 17, which satisifes the following conditions:
for a single transmission type diffusing plate,
5<(Sm/Ra)×(Ep/400)<70 (1)
for a double-transmission type diffusing plate,
10<(Sm/Ra)×(Ep/400)<80 (2)
for a front-surface reflection type diffusing plate,
50<(Sm/Ra)×(Ep/400)<200 (3)
for a back-surface reflection type diffusing plate,
80<(Sm/Ra)×(Ep/400)<250 (4)
where Sm is a mean pit-to-projection space of the surface according to JIS B0601 (μm), Ra is a center-line mean roughness of the surface (μm), and Ep is a distance (mm) from the diffusing surface of the diffusing plate to the position of a viewer's eye.

22. The image display system according to claim 18, which satisfies the following conditions:
for a single transmission type diffusing plate,
15<(Sm/Ra)×(Ep/400)<400 (5)
for a double-transmission type diffusing plate,
25<(Sm/Ra)×(Ep/400)<500 (6)
for a front-surface reflection type diffusing plate,
80<(Sm/Ra)×(Ep/400)<1,000 (7)
for a back-surface reflection type diffusing plate,
150<(Sm/Ra)×(Ep/400)<2,000 (8)
where Sm is a mean pit-to-projection space of the surface according to JIS B0601 (μm), Ra is a center-line mean roughness of the surface (μm), and Ep is a distance (mm) from the diffusing surface of the diffusing plate to the position of a viewer's eye.

23. The image display system according to claim 21, which satisfies the following condition:
Sm<200 μm (9)

24. The image display system according to claim 11, wherein said eyepiece optical system comprises a Fresnel lens.

25. The image display system according to claim 11, wherein said eyepiece optical system comprises a Fresnel reflecting mirror.

26. The image display system according to claim 11, wherein said eyepiece optical system comprises a Fresnel back-surface mirror.

27. The image display system according to claim 11, wherein said diffusing surface is provided on at least one surface of said eyepiece optical system.
